(19) United States
(12) Patent Application Publication
(10) Pub. No.: US 2016/0055498 A1
(43) Pub. Date: Feb. 25, 2016

(54) OBTAINING CONSUMER SURVEY RESPONSES AT POINT OF INTERACTION FOR USE TO PREDICT PURCHASING BEHAVIOR

(71) Applicant: MasterCard International Incorporated, Purchase, NY (US)

(72) Inventors: Qian Wang, Ridgeport, CT (US); Shen Xi Meng, Millwood, NY (US); Po Hu, Norwalk, CT (US)

(21) Appl. No.: 14/464,037

(22) Filed: Aug. 20, 2014

(51) Int. Cl. G06Q 30/02

(52) U.S. Cl. CPC G06Q 30/0203; G06Q 30/0269; G06Q 30/0217; G06Q 50/01

(57) ABSTRACT

Systems, apparatus and methods for obtaining consumer survey responses from a payment account holder at a point of interaction and then using that information to predict future consumer purchasing behavior. In an embodiment, at least one consumer survey question that represents a portion of a consumer survey poll is transmitted to a cardholder for display on a display screen at a point of interaction. The process includes receiving a response to the consumer survey question(s), storing the response(s) in association with purchase transaction data of the cardholder in a storage device, and then transmitting a commercial message personalized to the cardholder for display on the display screen at the point of interaction.

### FIELD OF THE INVENTION

The present invention generally relates to systems, apparatus and methods for obtaining consumer survey responses from a payment account holder at a point of interaction and then using that information to predict future consumer purchasing behavior. In an embodiment, consumer survey question responses to a brief consumer survey are obtained at, for example, a point-of-sale (POS) device during a purchase transaction, and a personalized commercial is displayed to the cardholder.

### BACKGROUND

Businesses strive to obtain knowledge about consumers in order to ensure that their business will be or will remain successful. For example, the development, manufacturing and marketing of a new product or service can represent a significant investment of time, effort, money and/or resources and thus many businesses will attempt to collect information about consumers who may be customers and/or prospective customers of such new products and/or services. In some cases, a business will hire a marketing company and/or a researcher to directly ask consumers questions concerning their identities, preferences and/or behaviors. The questions may be designed to solicit certain information about particular consumers or types of consumers, such as customers who reside in regions in which a business owns retail stores, and/or who belong to a particular socioeconomic group of consumers, and/or how often the consumers shop at the business' retail stores, and/or what factors influence their purchasing decisions, and/or what factors influence their consuming preferences. This information may be obtained by orally interviewing consumers, and/or by using written questionnaires, and/or by organizing focus groups, and/or by using telephone surveys or online surveys.

For example, a conventional print survey may be included with a purchased product, which requires a consumer to take the time to respond to survey questions provided on a self-addressed postage-paid postcard and then to mail it back to the manufacturer. But such surveys are ineffective when it comes to busy, lazy and/or indifferent consumers, and therefore only target certain personality types who will actually take the time and effort necessary to respond. Similarly, consumers who are asked to visit a website after completing a purchase to participate in a survey may not do so for the same or similar reasons, and thus substandard results are obtained because information from only a small portion of potential customers is captured.

To improve the response rate of print or online consumer surveys, some merchants offer incentives such as rebates, discounts, coupons and/or special offers to those persons who respond to survey questions. However, such programs can skew consumer responses, for example if the consumer thinks that his or her response will have an impact on the size or amount of the promised incentive. Furthermore, incentive programs often result in capturing responses from only extremely cost sensitive consumers, which may exclude the most valuable type of consumers who are more likely to pay full retail prices.

Furthermore, consumer survey responses can often be inaccurate, which can lead to skewed or inaccurate predictions regarding the probably of success of a new product or service or concept. An inaccurate forecast can be embarrassing for a business and/or a manufacturer and/or for the marketing agency that conducted a new product or service pre-launch survey, for example, which predicted a high purchasing level based on inaccurate consumer survey responses.

The inventors therefore recognized that an opportunity exists for providing methods and apparatus for improving the accuracy of consumer survey results data, which data could then be utilized and/or analyzed to provide accurate consumer preference assessments and/or accurate predictions of consumer purchasing intentions.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments (not necessarily drawn to scale), wherein:

FIG. 1 is a block diagram of a system for displaying a brief survey to cardholders during purchase transactions and for obtaining cardholder survey question responses for use in predicting consumer behavior according to some embodiments of the disclosure;

FIG. 2 depicts a credit card reader device that includes a display screen for displaying a brief consumer survey and a touch pad for receiving consumer responses in accordance with embodiments of the disclosure;

FIG. 3 is a flowchart illustrating a consumer purchase intention(s) process for obtaining consumer survey responses and using that information to predict future consumer purchasing behavior in accordance with some embodiments of the disclosure; and

FIG. 4 is a block diagram of a consumer information computer according to an embodiment of the disclosure.

### DETAILED DESCRIPTION

In general, and for the purpose of introducing concepts of novel embodiments described herein, provided are systems, apparatus and methods for obtaining consumer survey question responses to a brief survey during payment card purchase transactions at a point of interaction. The consumer survey responses are stored in a storage device, and a personalized commercial message is transmitted for display to the consumer (or cardholder) on a display screen at the point of interaction. In some embodiments, the consumer survey responses are used to perform consumer intent and action analysis. In particular, one or more predictions concerning that cardholder's future purchasing behavior may be generated and provided to an entity or entities (such as a client organization and/or a product manufacturer and/or a service provider and/or a merchant and/or a financial institution).

For example, a consumer who is a payment card account holder (a cardholder) makes a purchase at a point of interaction (POI), for example, at a retail store cash register (otherwise known as a Point-Of-Sale (POS) device or POS terminal) by swiping his or her credit card through a card reader associated with the POS device. Once the payment card is swiped, a display screen of the card reader may first present to the consumer an option to participate in a brief consumer survey in exchange for an incentive (such as a discount or rebate). If the cardholder provides an indication agreeing to participate, then a brief (for example, one, two or three questions) consumer survey is provided via the display screen of the cash register (the point of interaction). After the cardholder provides the required response or responses, in some implementations a personalized commercial message is generated and then displayed to the cardholder on the display device. The commercial message may be for a product or service of one or more entities involved with the consumer survey poll, and may be targeted to or customized for that cardholder based on, for example, the cardholder's historical purchase transaction pattern. Moreover, in some embodiments the cardholder's purchase transaction data and associated survey question responses are analyzed, over a predetermined time period, to determine one or more consumer purchase predictions and/or other consumer behavior predictions associated with that cardholder. The consumer purchase and/or behavior predictions can be provided to, for example, a product manufacturer, a services provider, and/or other types of businesses or organizations.

It should be understood that the brief consumer survey presented to the consumer at the point of interaction (such as on a display screen associated with a cash register) consists of only a few questions (for example, only one to five questions). The consumer survey questions may represent a small percentage or small portion of a consumer survey poll that contains many questions, and thus may be presented to the cardholder in a linear manner (or a piecemeal manner) over a predetermined time period (such as over a three-month period). It is generally known that consumers are more likely to agree to participate in a consumer survey and to answer survey questions truthfully if the consumer survey consists of a small number of questions as responding does not require too much effort from and/or take up too much time of the cardholder.

Consumers who own payment-enabled mobile devices, such as a mobile telephone that includes payment circuitry, can pay for a product or service by bringing the payment-enabled mobile device close to, or into contact with, for example, a contactless reader device of a merchant. In such cases, consumer data, such as the Primary Account Number (PAN) of the cardholder's payment card account, is read from the payment-enabled mobile device by the merchant's contactless reader device and then transmitted to a payment system for processing. According to some embodiments described herein, in exchange for an incentive such as a discount of the purchase price, the cardholder may then receive a brief consumer survey on a touch screen of his or her payment-enabled mobile device (such as on a Smartphone display screen) during payment processing. In such cases, the cardholder uses the touch screen of his or her payment enabled mobile device to respond to the consumer survey question or questions. Once the response or responses are entered and then transmitted by the payment-enabled mobile device to the payment system, the consumer may then receive a targeted and/or personalized commercial message on his or her mobile device. The consumer survey responses may then be recorded or stored in association with that cardholder's payment transaction data for later analysis in accordance with embodiments described herein.

Examples of consumer contactless payment-enabled mobile devices that could be utilized in such a manner include, but are not limited to, an iPad™ (or other tablet computer), an iPhone™ (or other type of Smartphone), a laptop computer, a digital music player, and a personal digital assistant (PDA). It should also be understood that the consumer could utilize other types of payment-enabled devices, such as a proximity payment card (such as a “PayPass®” proximity payment card offered by MasterCard International Incorporated, the assignee hereof), and in such cases the consumer survey may be provided to the cardholder, for example, on a touch display screen of the merchant's proximity card reader device (or other display device) which can be used to accept cardholder responses to the survey questions.

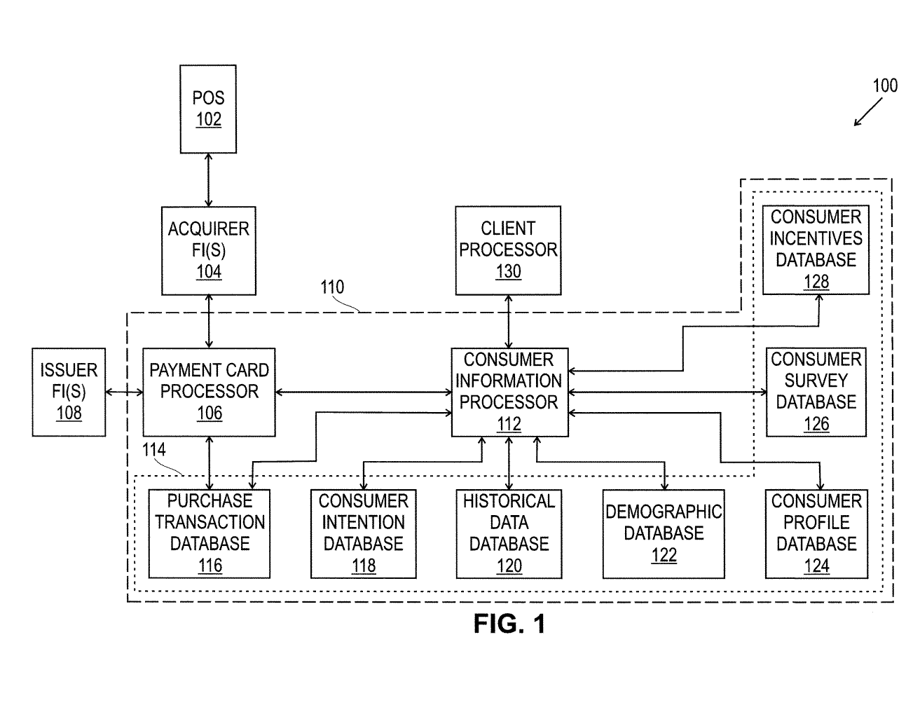

FIG. 1 is a block diagram of a system 100 for displaying a brief survey to cardholders or consumers and for obtaining cardholder survey question responses for use in predicting consumer behavior according to some embodiments. The system 100 may include a merchant's Point-Of-Sale (POS) device 102 with an associated card reader (not shown), an acquirer financial institutions (FI) 104 (having a financial account of the merchant) operably connected to the POS device 102, a payment card processor 106 operably connected to the acquirer FI 104 and to one or more issuer FIs 108 (which may be issuer banks, for example, that issue payment card accounts to their customers). In some embodiments, the payment card processor 106 is a component of a payment card network represented by dotted line 110, which may be operated and maintained by a payment card processing company such MasterCard International Incorporated, the assignee hereof. In some implementations, the payment card network 110 includes the payment card processor 106, a consumer information processor 112, and an enterprise data warehouse represented by dotted line 114. The consumer information processor 112 will be discussed in more detail below, and may be operably connected to the payment card processor 106, to the components of the enterprise data warehouse 114, and to a client processor 130. The client processor 130 may represent an entity, such as a business, a merchant, a marketing company, a service provider company and/or a manufacturer, and any one or more of such entities may desire information predictive of cardholder behavior with regard to purchasing one or more particular products or service offerings. Accordingly, in some implementations the client processor 130 represents an entity that has contracted with the owner of the payment card network 110 to receive consumer survey results data and/or consumer purchasing behavior prediction data associated with one or more cardholders.

In some embodiments, the enterprise data warehouse 114 includes a single data storage unit that contains other data warehouses or databases. The databases may be utilized and/or populated, for example, as a result of purchase transactions and/or by receiving responses to consumer survey questions and/or by the results of cardholder intention prediction processing and/or by other processes described herein. In some implementations, the enterprise data warehouse 114 contains a purchase transaction database 116, a consumer intention database 118, a historical information database 120, a demographic information database 122, a consumer profile database 124, a consumer survey database 126, and a consumer incentives database 128. Alternatively, the enterprise data warehouse 114 may be a logical representation of a grouping of such databases.

In some embodiments, the purchase transaction database 116 may include one or more databases configured for storing processed cardholder or consumer and merchant transaction data reports (for example, actual payment card account purchase transaction data associated with a cardholder and one or more merchants). In some embodiments, each transaction data report may include payment card account numbers that identify the consumer or cardholder (for example, a credit card account holder, or a prepaid card account holder, or a debit card account holder) and other or additional purchase transaction information. Examples of additional purchase transaction information include, but are not limited to, a purchase transaction amount (for example, in U.S. dollars or in Euros), a merchant or seller identifier, a retail store identifier, a POS identifier, a purchase transaction date, and/or a purchase transaction time. In some embodiments, the purchase transaction database 116 contains data corresponding to specific transactions in accordance with client requirements and/or survey output requirements, which may be for a specific period of time. For example, the purchase transaction database 116 may include a MasterCard™ purchase transaction database that records the actual purchase transactions conducted by users of MasterCard credit cards and/or debit cards and/or prepaid cards for a particular category of merchants (for example, shoe retailers or restaurants of supermarkets). In some embodiments, the purchase transaction data stored in the purchase transaction database 116 may be collected for a predefined period of time (e.g., 3 months) that could start after and/or during a given customer survey poll period (which will be discussed in further detail herein).

Consumer intention database 118 may include one or more databases configured for storing consumer intention information obtained from consumers or cardholders via their responses to survey questions. For example, all of the cardholder survey question responses from a given survey period (e.g., a three month period that started in January and ended in April of a particular year) may be stored for analysis and processing to predict a particular consumer's purchase intention(s). In accordance with described embodiments, any particular consumer or cardholder survey poll may be provided to the cardholder in a linear fashion, meaning that the consumer survey poll questions may be presented in piecemeal fashion over time. For example, each time a particular cardholder performs a purchase transaction over the course of a specific two month period at a particular merchant (either at the merchant's retail store or online at a merchant website), that cardholder is presented with one to three survey questions at a time, wherein the entire consumer survey poll may consist of a total of twenty-five survey questions, for example. In this manner, the cardholder is not overburdened or overwhelmed during any one particular purchase transaction by being asked to respond to a large number of survey questions. As explained herein, some of the consumer survey questions may be designed to gauge the likelihood that a particular cardholder will purchase a particular type of product or service, while other types of consumer survey questions may be included that do not directly pertain to any products or services. For example, consumer survey questions could include questions pertaining to social issues, politic issues, and/or religious beliefs.

Instead of presenting a brief consumer survey to a cardholder at a merchant's POS device, consumer survey poll questions for collecting data related to consumer purchase intentions may be transmitted for presentation on a display screen of the consumer's payment-enabled mobile device, or as an Internet or web-based questionnaire or survey at a merchant's website, or as a printed form questionnaire or survey that may be provided to the cardholder by a cashier or other manner, or by any other technique that may be used to obtain the cardholder's responses to survey questions in the course of a purchase transaction. In some embodiments, participation in such brief consumer survey polls may be by consumers who have opted-in or otherwise chosen to participate to have their cardholder purchase transaction data and survey responses used to model consumer behavior (for example, by the cardholder completing a permission form at their issuer financial institution, which may be required in some jurisdictions in order to comply with consumer privacy regulations, for example).

Referring again to FIG. 1, the historical data database 120 may include one or more databases that contain past consumer or cardholder purchase transaction records, similar to the purchase transaction database 116. However, the historical information database 120 may be configured to store actual or general purchase transaction records conducted by consumers over a long time period (for example, six months, or one or more years) with or without associated consumer survey responses. For example, the historical data database 120 may include data associated with all of the purchase transactions of consumers who used MasterCard® debit cards over a two year period of time to purchase goods and/or services from various types of merchants. Like the purchase transaction database 116, the historical information database 120 may contain transaction data reports that include cardholder account numbers that identify each consumer in the database along with other purchase transaction information, such as a purchase transaction amount, a merchant/seller identifier, a transaction date and transaction time.

Demographic database 122 may include one or more databases configured to store supplemental consumer information associated with each consumer's payment card account number that are contained in the purchase transaction reports in the purchase transaction database 116. The supplemental information may include data that is specific to each consumer or cardholder, including information such as demographic information (age and/or age groups), a residential address, and a ZIP code. In some embodiments, the demographic information database 122 may also include consumer information obtained from external sources. For example, the consumer information processor 112 of FIG. 1 may be configured and/or operable to retrieve Twitter™ status update data and/or a Facebook™ status update data and/or other social network data associated with one or more cardholders related to the purchasing behavior of those cardholders. Thus, in some implementations the consumer information processor 112 can be configured to analyze the Twitter™ and/or a Facebook™ and/or other social network data (for example by utilizing natural language processing) to determine, for example, if the cardholder has recently made at least one change to at least one of his or her product preferences or purchasing intentions. If so, the recently changed or updated consumer preferences and/or consumer intentions data can be added to the consumer intention database 118 and/or to the consumer profile database 124, if appropriate. In addition, the demographic information database 122 may store additional consumer related information that may be associated with a particular consumer's gender, age, ethnicity, race, marital status, disabilities, home ownership, employment status, income level, education level, and the like.

The consumer profile database 124 may include one or more databases that are configured to store consumer profile data. For example, consumer profile data may include data fields corresponding to conventional consumer profiling attributes and/or characteristics (for example, demographic and gender attributes). In some embodiments, the consumer profile database 124 may also include an intention-action model score that may be determined or generated by the consumer information processor 112, for example. Such an intention-action model score may be indicative of whether or not a particular consumer or cardholder is likely to purchase a particular good or service within a particular period of time (for example, within the next six months) based on previously indicated intent data obtained from that cardholder via responses to one or more of the consumer survey poll questions. In general, predictive scores may be utilized as part of the consumer profile data. For example, a consumer's FICO score, which is a measure of a consumer's creditworthiness and thus commonly used by financial institutions such as issuers of payment card accounts, may be included as part of the consumer profile data.

The consumer survey database 126 may include one or more databases configured for storing consumer survey polls and/or consumer survey questions that have been developed to obtain consumer intention information. As mentioned earlier, a particular consumer survey poll may be composed of multiple questions with a small portion being presented to a consumer or cardholder during a particular transaction, wherein all of the questions are presented over time. For example, a particular in-depth consumer survey poll may include thirty (30) questions or more, but one or more cardholders would only be presented with two or three of the survey questions at a time (during purchase transactions) over a predetermined period of time, such as a three-month period. The survey questions may be generated by the consumer information processor 112 based on input from the client processor 130 (which is associated with an entity desiring to obtain consumer intention information regarding one or more products or services). Alternately, the consumer survey questions and/or consumer survey polls may be provided by one or more entities to the consumer information processor 112 for storage in the consumer survey database 126, and then those survey questions used to conduct consumer surveys of cardholders during purchase transactions. In addition, in some implementations the consumer survey questions may be updated dynamically and/or automatically as a particular cardholder responds to one or more of the survey questions of a particular consumer survey poll. For example, if a cardholder responds to one or more political questions in a particular manner, for example by designating himself or herself to be a registered Democrat and a voter, then follow-up consumer survey questions directed to or associated with that political party (and/or to or with voters in general) may be selected for future presentation to the cardholder while other survey questions are discarded. Thus, a particular consumer survey poll may be structured in such a manner to present certain survey questions that depend upon responses received from a particular cardholder.

The consumer incentives database 128 may include one or more databases configured for storing consumer incentives such as discount offers, cash-back offers, rebate offers, coupon offers, loyalty point offers, frequent flier mileage point offers, and the like for presentation to cardholders in return for answering consumer survey poll questions. In some implementations, the consumer incentives database 128 may be populated with incentive offers from one or more entities, such as merchants or manufacturers, who wish to obtain consumer intention information regarding one or more products or services. Such incentives may be selectable by the consumer information processor 112 during a purchase transaction depending on the context of a particular purchase transaction and then presented to the cardholder. For example, during the course of a purchase transaction at a pet supply store, a cardholder may be presented with a discount and/or a coupon offer for pet food that can be displayed on a display screen of a card reader associated with the POS device to the cardholder in exchange for responding to the consumer survey questions. In some implementations, the process may include presenting two or more incentive offers to a consumer or cardholder, wherein the consumer can select one if he or she agrees to answer consumer survey questions.

Referring again to FIG. 1, the consumer information processor 112 may be operatively connected to each of the databases 116 to 128 of the enterprise data warehouse 114 as shown. Although the consumer information processor 112 is depicted as a single component, it may include a plurality of processors and/or computers and/or data processing modules (not shown) configured to process consumer related data and to generate and utilize an intention-action model score via the methods described herein. Thus, the consumer information processor 112 may include a plurality of network elements, a plurality of network components, and/or a network itself. For example, in some embodiments, each of the data processing modules described herein may be hosted by its own processing server, and the plurality of host processing servers may compose a processing system. In some embodiments, the consumer information processor 112 may include a microprocessor (not shown), or a central processing unit (CPU), or any other like hardware based processing component that is configured to execute and/or utilize the processes described herein.

In some embodiments, the system 100 of FIG. 1 may be implemented using conventional computer hardware, processing units, and/or application software configurations including, for example, distributed server systems. The system 100 also may include other hardware and/or software components that are not shown in FIG. 1, such as one or more user input terminals, database query tools, and one or more output devices (such as a printer, display screen, and the like). In addition, each of the depicted databases 116-128 shown in FIG. 1 may be composed of memory devices, non-transitory computer readable storage devices, and/or computer-readable media, such as random access memory (RAM), read only memory (ROM), optical read/write memory, bubble memory, cache memory, magnetic read/write memory, flash memory, and the like.

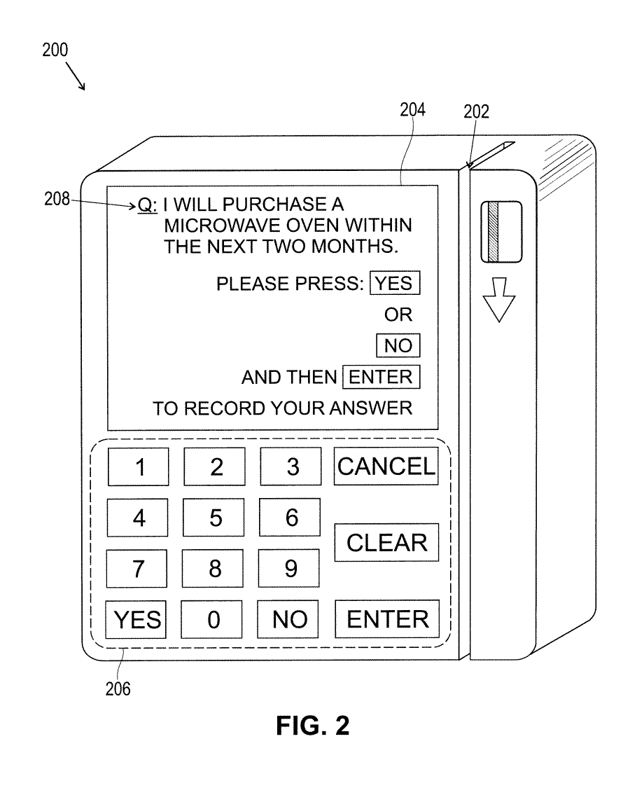

FIG. 2 depicts an embodiment of a merchant's credit card reader device 200 that includes a display screen 204 (which may be a touch screen) that may be used to display a brief consumer survey, and that has a touch pad 206 which may be used by a cardholder to provide responses to one or more consumer survey questions. The credit card reader device 200 also includes a slot 202 for use by a cardholder to swipe the magnetic stripe of his or her credit card or debit card. In an embodiment, the credit card payment device 200 is located adjacent a gas pump at a gasoline station, and a cardholder must first swipe his or her credit or debit card before pumping gas. Thus, during a gasoline purchase transaction at the gas station (after the cardholder has swiped his debit card or credit card or gas company credit card through the slot 202), the cardholder may be presented with a consumer survey query or question 208 on the display screen 204 of the credit card reader device 200. In the example shown, the consumer is presented with a statement: “I will purchase a microwave oven within the next two months.” that includes directions to press “Yes” or “No” key of the touchpad 206 and then an “Enter” key to record the response. This consumer survey question may represent a small portion of a consumer survey poll which may have been paid for by, for example, an electronics merchant. In some implementations, before any survey questions are displayed, an incentive offer (or several incentive offers) to provide survey questions responses may appear on the display screen 204. For example, an incentive offer may be an offer to discount the transaction price of the gasoline by two-percent (2%) in exchange for the consumer responding to the question(s). In such a case, if the consumer enters “Yes” by pushing the appropriate touch pad key, then the survey question 208 appears along with instructions regarding which keys to press and/or how to otherwise provide a response (for example, by touching an icon on a touch screen).

Referring again to FIG. 2, after the consumer presses the “Yes” or “No” key to the survey question and then the “Enter” key, his or her response is transmitted to the payment card network 110 (see FIG. 1) and stored in the consumer intention database 118. Next, in some implementations the consumer information processor 112 selects a personalized commercial message and then transmits it to the merchant's reader device 200 for display on the display screen 204 for viewing by the consumer as he or she is pumping gasoline into the gas tank of the automobile. The commercial message may, for example, promote a product or service that is based on that consumer's (cardholder's) historical purchasing transaction pattern and/or other factors, which product or service may be related to (or unrelated to) the gasoline station or to the entity sponsoring the consumer survey poll. The methods described herein thus leverage an intention-action model, which has been found to be more robust than processes that incorporate the consumer's internal intentions.

In some embodiments, the consumer survey questions may be designed to inquire as to the degree to which a queried consumer intends to purchase a particular product by utilizing a scaling system (for example, by using a scale ranging from 1 to 5). Each number value of the scale may represent an intensity of the likelihood that the consumer believes that he or she will ultimately purchase the product. For example, selecting the value of “5” may indicate that the consumer strongly believes that he or she will purchase a particular product within two months (such as a microwave oven in the example explained above with regard to FIG. 2), whereas selecting the value of “1” may indicate that the consumer strongly believes that he or she will not purchase the product. The value “4” may indicate that the consumer believes that he or she will likely to purchase the product, whereas the value “3” may indicate that the consumer is uncertain as to whether or not he or she will purchase the product, and the value “2” may indicate that the consumer believes that he or she is unlikely to purchase the product within the predetermined time period. Although the present example utilizes a scale of 1 to 5, other scales (e.g., 1 to 7, 1 to 10, 1 to 100, etc.) may be used. Such detailed survey poll data (cardholder responses) may be collected from consumers via any of the methods mentioned herein and stored in the consumer intention database 118.

In some embodiments, as mentioned above the consumer survey questions may be related to issues other than products or services. For example, consumer survey questions of a particular consumer survey poll may be related to social and/or political issues that may be important to particular cardholders and/or to the entity that is sponsoring the consumer survey poll. Thus, consumer survey questions may include questions related to political candidates, political parties, voting, political issues, government issues, social issues, community issues, religious issues and the like. In some cases, one or more of such consumer survey questions may utilize a scale to gauge the amount of the consumer's interest in any particular issue as described above.

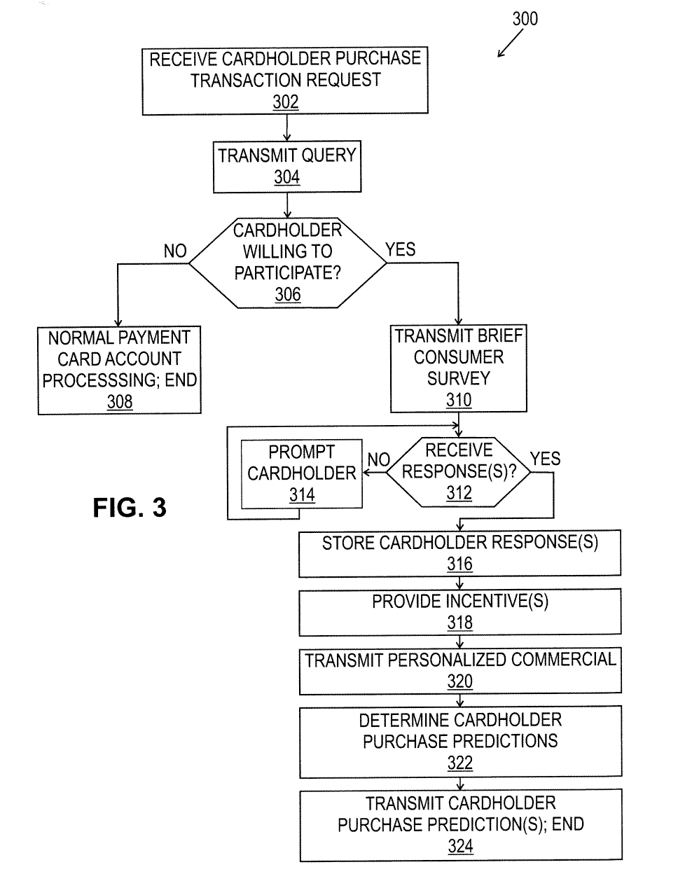

FIG. 3 is a flowchart illustrating a consumer purchase intention(s) process 300 for obtaining consumer survey responses and using that information to predict future consumer purchasing behavior in accordance with some embodiments. A payment card system receives 302 a purchase transaction request of a cardholder. The purchase transaction request may originate from any number of points of interaction (POI), for example, from a merchant's credit card reader or contactless card reader associated with a POS device, or from the checkout page of a merchant's website. After receipt of the purchase transaction request, the payment card system transmits 304 a query to the POI for display to the cardholder, for example, on a contactless card reader display screen. The query may be a question asking the cardholder if he or she is willing to respond to a brief consumer survey, and may include one or more incentives, such as a purchase price discount offer or coupon or rebate, in exchange for the cardholder agreeing to provide the response(s). If in step 306 the cardholder does not agree to participate in the consumer survey, then normal payment card account processing is conducted 308 and the process ends. In some implementations, the cardholder may press a “No” key or icon when he or she is not willing to participate in the consumer survey.

However, if in step 306 the cardholder agrees to participate in the brief consumer survey, then one or more survey questions are transmitted 310 to a card reader device and displayed on a display screen or otherwise presented to the cardholder. It should be understood that the consumer survey questions may be presented to the consumer in any manner feasible, such as on a display screen of a cardholder's payment-enabled mobile device, or on a display screen of the cardholder's personal computer, and in some embodiments may be orally read to the consumer by store personnel (who may also enter the responses from a consumer). In some implementations, the consumer survey questions may be audibly presented to a consumer, for example by utilizing a speaker or speakers on a consumer's mobile device or speakers associated with other electronic devices.

Referring again to FIG. 3, if in step 312 a response is not received from the consumer within a predetermined amount of time, then the payment card system transmits 314 a prompt to the cardholder or consumer to provide the response(s). In some embodiments, if the cardholder fails to provide the response(s) within a predetermined time period then the process may then conduct normal payment card processing and then end (as in step 308). However, if the consumer survey response(s) are received within a predetermined time period (which may be on the order of thirty (30) seconds to two (2) minutes or longer) then the cardholder response(s) are stored 316 and the promised incentive(s) (if any) are provided 318. Next, the payment card system may analyze cardholder data and then select and transmit 320 a personalized or targeted commercial message for display to the cardholder. Such a commercial message may promote a particular product or service associated with the entity sponsoring the consumer survey poll or may promote other entities and/or ideas (for example, the commercial may be an advertisement for a product or service, or may encourage voting for a particular candidate or political party). In some embodiments, the payment card system next determines 322 one or more cardholder or consumer purchase predictions, and then transmits 324 the cardholder prediction information to an entity or entities that engaged the payment card system operator to analyze the consumer survey data and provide such consumer prediction data. A particular cardholder purchase prediction may be based on, for example, the responses provided by that cardholder to the consumer survey questions (cardholder intention data) and/or historical data of the cardholder, and/or demographic data associated with the cardholder.

It should be understood that the process illustrated by the flowchart of FIG. 3 is an example and should not be considered as requiring a fixed order for performing the process steps. Rather, the process steps may be performed in any order that is practicable, including simultaneous performance of at least some steps. It should also be understood that, in some implementations of the processes described herein, one or more of the process steps shown in FIG. 3 may be omitted.

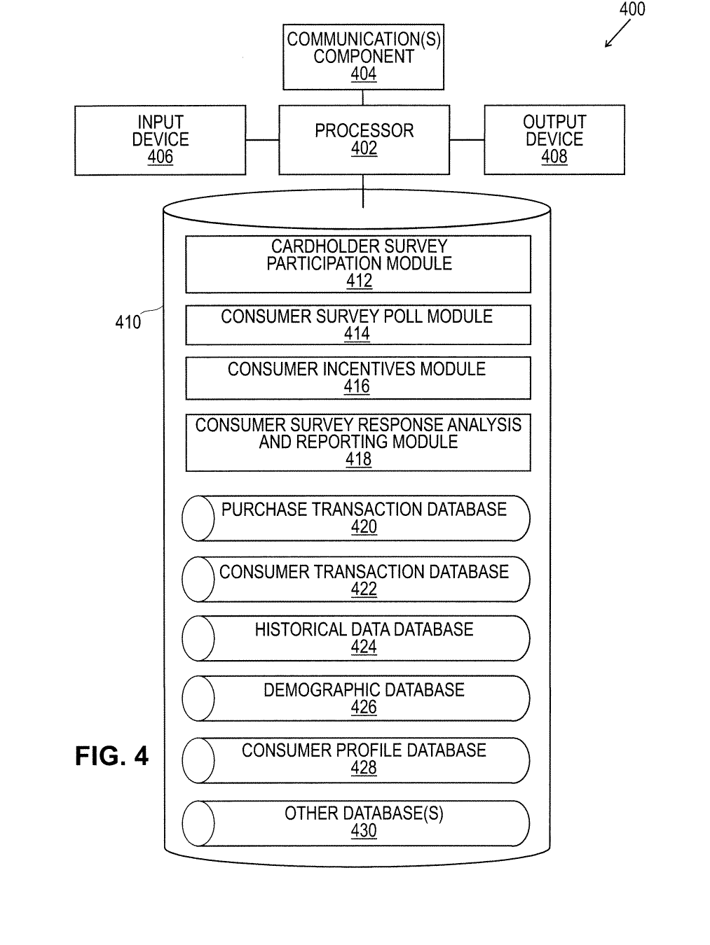

FIG. 4 is a block diagram of a consumer information computer 400 according to an embodiment. The consumer information computer 400 may be conventional in its hardware aspects but may be controlled by software to cause it to operate in accordance with aspects of the methods presented herein. In particular, the consumer information computer 400 may include a computer processor 402 operatively coupled to a communication component 404, an input device 406, an output device 408, and a storage device 410.

The computer processor 402 may constitute one or more conventional processors. Processor 402 operates to execute processor-executable steps, contained in program instructions described herein, so as to control the consumer information computer 400 to provide desired functionality.

Communication component 404 may be used to facilitate communication with, for example, other devices (such as for receiving data from one or more client computers associated with entities desiring to obtain consumer purchasing behavior predictions) by engaging, for example, in data communications over conventional computer-to-computer data networks. Such data communications may be in digital form and/or in analog form.

Input device 406 may comprise one or more of any type of peripheral device typically used to input data into a computer. For example, the input device 406 may include a keyboard and a mouse and/or a touchpad that may be used, for example, by a systems engineer or other personnel authorized to, for example, perform consumer information computer system maintenance or other task. The output device 408 may comprise, for example, a display and/or a printer.

Storage device 410 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory devices. Any one or more of the listed storage devices may be referred to as a “memory”, “storage”, “non-transitory computer readable media”, or a “storage medium”.

Storage device 410 stores one or more programs or applications or modules for controlling processor 402. The programs or applications or modules comprise program instructions that contain processor-executable process steps of the consumer information computer 400, including, in some cases, process steps that constitute processes provided in accordance with principles of the processes presented herein.

The programs may include a cardholder survey participation module 412 that manages a process by which consumers are queried regarding their willingness to participate in a consumer survey poll, and that may also operate to store the consumer responses to survey questions. In addition, the storage device 410 may include a consumer survey poll module 414 that manages a process by which consumer survey polls are developed (or obtained from one or more entities) and then utilized, including determining the total number of survey questions of a particular survey poll and how many survey questions to be transmitted to a cardholder during any particular purchase transaction. Also included may be a consumer incentives module 416 that manages a process whereby a cardholder is offered one or more incentives for participating in a brief consumer survey, and that provides the cardholder with the incentive(s) after the responses are received. A consumer survey response analysis and reporting module 418 may also be included, which may be configured to analyze the consumer responses and generate one or more predictions concerning the purchasing behavior of one or more particular cardholders and report the predicted purchasing behavior to one or more entities (such as a merchant and/or a product manufacturer and/or a service provider).

In addition, the storage device 410 may include a purchase transaction database 420, a consumer intention database 422, a historical database 424, a demographic database 426, a consumer profile database 428, and one or more databases 430 that are maintained by the consumer information computer 400 on the storage device 410.

The application programs of the consumer information computer 400, as described above, may be combined in some embodiments, as convenient, into one, two or more application programs or program modules. Moreover, the storage device 410 may store other programs or applications or modules, such as one or more operating systems, device drivers, database management software, web hosting software, and the like.

Accordingly, by utilizing the apparatus, systems and processes presented herein, an entity such as a merchant and/or product manufacturer and/or service provider can be provided with the opportunity to discern future cardholder or consumer purchasing behavior and may utilize such information to react to the purchasing intentions and/or the preferences of the consumers and thus to provide a superior level of service. Furthermore, in some embodiments, through participation in the processes described herein (by responding to consumer survey questions), consumers have the opportunity to receive personalized commercials for consideration and/or to obtain customized or targeted incentive offers such as discounts and/or coupons from merchants in real-time that are highly relevant to the consumer and that may be based on the consumers' needs.

In the particular example, in the field of women's apparel (AAW), responses to consumer survey questions can provide important and valuable information concerning customers' opinions toward women's clothing products. Traditional survey methodology focuses on women's intention opinions, which may not match their actual actions (purchasing behavior), and thus the present systems and methods provide a hard link between a woman's survey question responses and their actual purchase actions. In particular, women's clothing designers can greatly benefit from knowing their customers' opinions concerning current women's clothing fashion and design, as well as the impact of the opinions on actual shopping selections (made at a later date). Thus, the present simple, low cost, accurate and efficient customer survey process may be tuned to collect customer survey responses from female cardholders pertaining to the women's apparel industry, store such survey data, and then automatically perform intention-action processing and advanced statistical analyses to predict cardholders women's apparel purchasing behavior. Such predictions of customer needs can significantly improve women's apparel marketing strategies, including advertising campaigns, new product development, and existing product management.

As used herein and in the appended claims, the terms “initiating a transaction” and/or “during a purchase transaction” includes a proximity payment device such as a payment-enabled mobile telephone or other contactless payment device communicating with a reader device that may be associated with a POS terminal. The terms “initiating a transaction” and/or “during a purchase transaction” can also include a payment-enabled mobile device communicating with a website to transmit and receive data so as to enter into on-line purchasing transactions or payment transactions.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
transmitting, by a processor during a purchase transaction, at least one consumer survey question for display on a display screen to a cardholder at a point of interaction, the at least one consumer survey question representing a portion of a consumer survey poll;
receiving, by the processor, at least one response to the at least one consumer survey question;
storing, by the processor in a storage device, the at least one response in association with purchase transaction data of the cardholder; and
transmitting, by the processor, a commercial message personalized to the cardholder for display on the display screen at the point of interaction.

2. The method of claim 1, further comprising, prior to transmitting the at least one consumer survey question:
receiving, by the processor, a cardholder purchase transaction request from a point of interaction; and
selecting, by the processor based on at least one of historical data and demographic data and consumer profile data of the cardholder, the at least one consumer survey question.

3. The method of claim 2, further comprising, prior to selecting the at least one consumer survey question:
determining, by the processor, that the cardholder updated at least one cardholder preference on a social network website; and
updating, by the processor, at least one of the demographic data and the consumer profile data of the cardholder in accordance with the at least one updated cardholder preference.

4. The method of claim 3, wherein the social network website comprises a website associated with at least one of Twitter™, Facebook™, and LinkedIn™.

5. The method of claim 1, further comprising, prior to transmitting the at least one consumer survey question:
receiving, by the processor, a cardholder purchase transaction request from a point of interaction;
transmitting, by the processor, a query requesting the cardholder to indicate a willingness to participate in a consumer survey poll; and
receiving, by the processor, an indication from the cardholder of agreement to participate in the consumer survey poll.

6. The method of claim 5, wherein the query further comprises an incentive offer for the cardholder in exchange for agreeing to participate in the consumer survey poll.

7. The method of claim 6, further comprising, providing the incentive to the cardholder after receiving the at least one response to the at least one consumer survey question.

8. The method of claim 5, wherein the incentive offer comprises at least one of a rebate offer, a cash-back offer, a discount offer, and a coupon.

9. The method of claim 1, further comprising, prior to transmitting the commercial message, determining, by the processor, a commercial message personalized to the cardholder based on at least historical purchase transaction data of the cardholder.

10. The method of claim 1, further comprising storing, by the processor, cardholder responses to survey questions received during a predetermined period of time.

11. The method of claim 10, further comprising determining, by the processor when the predetermined period of time expires, at least one cardholder purchase prediction based on the consumer survey poll question responses.

12. The method of claim 11, further comprising transmitting, by the processor the at least one cardholder purchase prediction to a computer associated with at least one entity.

13. The method of claim 12, wherein the entity comprises at least one of a manufacturer, a merchant, or a financial institution.

14. The method of claim 1, wherein the display screen of the point of interaction comprises one of a display screen of a point of sale (POS) device, a personal computer display screen displaying a merchant website webpage, a display screen of a payment-enabled mobile device of the cardholder, or a display screen of a contactless device of the cardholder.

15. An apparatus comprising:
a processor;
a communication component operably connected to the processor; and
a storage device operably connected to the processor and storing instructions configured to cause the processor to:
transmit at least one consumer survey question during a purchase transaction for display on a display screen to a cardholder at a point of interaction, the at least one consumer survey question representing a portion of a consumer survey poll;
receive at least one response to the at least one consumer survey question;
store the at least one response in association with purchase transaction data of the cardholder in the storage device; and
transmit a commercial message personalized to the cardholder for display on the display screen at the point of interaction.

16. The apparatus of claim 15, wherein the storage device further comprises instructions configured to cause the processor to, prior to transmitting the at least one consumer survey question:
receive a cardholder purchase transaction request from a point of interaction; and
select the at least one consumer survey question based on at least one of historical data and demographic data and consumer profile data of the cardholder.

17. The apparatus of claim 15, wherein the storage device further comprises, prior to the instructions for selecting the at least one consumer survey question, instructions configured to cause the processor to:
determine that the cardholder updated at least one cardholder preference on a social network website; and
update at least one of the demographic data and the consumer profile data of the cardholder in accordance with the at least one updated cardholder preference.

18. The apparatus of claim 14, wherein the storage device further comprises, prior to the instructions for transmitting the at least one consumer survey question, instructions configured to cause the processor to:
receive cardholder purchase transaction request from a point of interaction;
transmit a query requesting the cardholder to indicate a willingness to participate in a consumer survey poll; and
receive an indication from the cardholder of agreement to participate in the consumer survey poll.

19. The apparatus of claim 18, wherein the instructions for transmitting the query regarding willingness to participate in the consumer survey poll further comprises instructions configured to cause the processor to transmit an incentive offer to the cardholder redeemable after the cardholder agrees to participate in the consumer survey poll and responds to the consumer survey question(s).

20. The apparatus of claim 15, wherein the storage device further comprises, prior to the instructions for transmitting the commercial message, instructions configured to cause the processor to determine a commercial message personalized to the cardholder based on at least historical purchase transaction data of the cardholder.

21. The apparatus of claim 15, wherein the storage device further comprises instructions for causing the processor to store cardholder responses to consumer survey questions received during a predetermined period of time in the storage device.

22. The apparatus of claim 21, wherein the storage device further comprises instructions configured to cause the processor to determine at least one cardholder purchase prediction based on the consumer survey poll question responses after the predetermined period of time expires.

23. The apparatus of claim 22, wherein the storage device further comprises instructions configured to cause the processor to transmit the at least one cardholder purchase prediction to a computer associated with at least one entity.
